(19) United States
(12) Patent Application Publication
(10) Pub. No.: US 2013/0121192 A1
(43) Pub. Date: May 16, 2013

(54) MEASURING MESSAGE STREAM QUALITY ACROSS NETWORKS

(71) Applicant: Path Solutions, Inc., Sunnyvale, CA (US)

(72) Inventor: Timothy G. Titus, Sunnyvale, CA (US)

(73) Assignee: PATH SOLUTIONS, INC., Sunnyvale, CA (US)

(21) Appl. No.: 13/675,919

(22) Filed: Nov. 13, 2012

Related U.S. Application Data
(60) Provisional application No. 61/558,300, filed on Nov. 10, 2011.

(51) Int. Cl. H04L 12/26

(52) U.S. Cl. CPC H04L 43/0829; H04L 43/087
USPC 370/252

(57) ABSTRACT

Service message streams are sent to create sent service messages from a source across networks to a destination and receive responses to the sent service messages to create an estimate of the jitter in the travel time and a packet loss measurement at each device traversed between the source and destination. Communication with the service provider of one of the devices may estimate the quality of service across each device based upon the jitter estimate and packet loss measurement, and possibly also based upon the service message type and/or the message rate. Multiple sources may be operated at multiple sites within an enterprise. The service provider may operate agents at the source and destination to estimate two-way quality of service.

### CROSS REFERENCE TO RELATED APPLICATIONS

This application claims the benefit of U.S. Provisional Application No. 61/558,300, filed Nov. 10, 2011, which is incorporated herein by reference in its entirety.

### FIELD OF THE INVENTION

Embodiments of the invention measure a response to a message sent through a communications network and determine from the measured response a parameter related to quality of service in the communications network.

### BACKGROUND

Communications networks operating in accord with messaging protocols provide messaging services used by millions of people to access the World Wide Web, conduct Voice Over Internet Protocol (VOIP) telephone calls, stream video and audio data, and many other activities. These messaging services have greatly changed the world culture over the last twenty years, making the planet much more of a global village. One aspect of managing a message service is measuring the quality of service. Some messaging services have different requirements for quality of service than other messaging services. A parameter or group of parameters used to assess quality of service for a messaging service may differ from parameters used to assess quality of service for another messaging service. For example, quality of service may be related to parameters including, but not limited to, prioritization of data packets, service response time, echo, probability or number of service interruptions, reserve capacity, cross-talk, loudness, frequency response, parameters related to data flow such as bit rate, delay, or jitter, and probability of dropping packets. Quality of service may be based on subjective evaluation by a user, for example subjective evaluation of picture quality or audio quality.

Messaging services may employ streams of messages sent from a source device to a destination device across multiple networks. Passing a message from one device such as a router or gateway to another router or gateway is referred to as a hop. A hop occurs each time data representative of a message, for example a data packet, passes from one device to the next in a chain of devices from the source to the destination. Different messaging services may perform differently from one another for a traversal across a same device, also referred to as a hop across the device, for example by having different traversal times.

A message, as used herein, includes a wrapper and a data payload, either one or both of which may be empty. The wrapper may include a messaging service indication and a device count. In some communications protocols, the device count may be referred to as a hop count, or in others, a total time to live. The wrapper may be implemented as a header of the payload data, as a trailer, or as both a header and a trailer of the data payload. The device count represents the total number of devices a given message may pass through from the source to the destination. A device being traversed examines the device count and discards the message if the message's device count is zero. Discarding a message with a device count of zero prevents the message from endlessly bouncing around a network.

For example, a phone call using VOIP is carried across a chain of interconnected devices, such as routers. A crossing of the data representing the phone call from one device to the next constitutes one hop. Each device in the chain may cause messages to hop between a network connection, through the device, to another network. Each device decrements the device count of the message at each hop. The call may be dropped in some situations, or there may be gaps in the conversation. When a dropped call or gap occurs, it is important to determine which hop caused the quality problem in order to locate the weak point in the quality of service. Once determined, the quality weak point can be communicated to a service provider, who may resend the data or take other corrective action.

A router is an example of a device that may join multiple communication networks together. Some examples of a router may be used to join multiple wireline networks, for example, Ethernet networks. Other examples of a router, for example a home network router, may use a combination of interfaces to join a wide-area network (WAN), Local Area Network (LAN), or a wireless LAN (WLAN), or any combination of two or more of these networks. A router may, or may not, include the functionality of a bridge, a device that filters traffic for at least one network boundary by inspecting incoming messages to determine whether to forward those messages or discard them. Other examples of devices through which messages may pass from one communications network to another network include, but are not limited to, a gateway, a firewall, a network switch, a brouter, a bridge router, and a computer server configured to include a router.

Network utilities may be used to measure a round-trip time for messages sent from a source device to a destination device. Ping is an example of a well-known network utility. Ping may generate messages in the Internet Control Message Protocol, for example by designating a message as an echo request packet. An echo packet is a message generated in response to an echo request. When the message from the source device is received by the specified destination, the destination sends an echo packet back to the source device, allowing the source device to measure the time interval from sending the Ping message until the echo message returns. An echo packet may take the form of an echo reply, an ICMP (Internet Control Message Protocol) message generated in response to an echo request. The measured time interval from transmission of the Ping message from a sending device to receipt of the echo packet at the sending device may be referred to as the travel time. Ping can also record whether the echo packet is never received, providing a means for estimating packet loss. Ping may further show a statistical summary of response messages and may include one or more results such as the response packets received, the minimum, maximum and mean round-trip times, and possibly the standard deviation of the mean.

Traceroute is another example of a network utility. Traceroute traces an echo request packet from a source device to a destination device. An example of a destination device is an Internet host computer. Traceroute shows a count of how many hops it took to reach the destination from the source and a travel time across each hop. Traceroute sends echo request packets with low hop count fields. The hop count field value specifies how many hops the packet is allowed before it is stopped. If the echo request packet's hop count decrements to zero, the packet is terminated and a return packet stating that the packet terminated is sent to the source. On the other hand if the echo request packet arrives at the destination, the destination sends an echo packet back to the source. The travel times for packets with hop counts of one give the travel time across the first hop. The travel times for packets with hop counts of two give the travel time across the first and second hop. By subtracting these travel times, the travel time across the second hop can be determined. Processing of the successive hop count packet travel times leads to knowing how many hop counts are required to send a message from the source to the destination, and the travel time across each hop.

A service provider's response to a denial of service attack may interfere with operation of a network utility. For example, Ping, while very useful, has been used as a central tool in denial of service attacks on network devices by creating a flood of echo request messages to a router, slowing the legitimate message traffic across the router or even bringing the message traffic to a halt. Because of this, a communications service provider may configure network devices to either no longer respond to echo request messages, for example echo request messages from Ping or other network utilities, or severely throttle the number of accepted echo request messages. These configurations may eliminate this security flaw from their networks. Suppression or throttling of echo request messages makes network utilities like Ping and Traceroute less accurate and less reliable for managing messaging services or for managing communication networks.

### SUMMARY

An example of a method embodiment of the invention includes the steps of sending a stream of service message to create sent service messages from a source across networks to a destination, and receiving responses to the sent service messages to create an estimate of jitter in a travel time between the source and the destination of the stream of service messages and a packet loss measurement of the stream of said service messages.

An example of an apparatus embodiment of the invention includes means for sending a stream of service messages to create sent service messages from a source across networks to a destination, and means for receiving responses to the sent service messages to create an estimate of jitter in a travel time between the source and the destination of the stream of service messages and a packet loss measurement of the stream of the service messages.

This section summarizes some features of the present invention. These and other features, aspects, and advantages of the invention will become better understood with regard to the following description and upon reference to the following drawings.

### BRIEF DESCRIPTION OF THE DRAWINGS

FIGS. 1A to 1C show examples of a method for sending a stream of service messages from a source through more than one network to a destination to create quality of service estimates for the entire path and for the devices traversed.

FIG. 2 shows that a message service indication may be, for example, Voice Over Internet Protocol (VOIP), Web access, a video phone, gaming or possibly 3-D gaming, video, and Virtual Desktop Infrastructure (VDI).

FIGS. 3A to 3C show some examples of sending the stream of service messages at a specific message rate.

FIG. 4 shows an example of sending multiple streams for more than one of the specific messaging services.

FIG. 5 shows the jitter, the packet loss and the travel time may be generated for more than one specific message rate, and for more than one messaging service, where a quality of service estimate for a message service may indicate traffic throttling.

FIG. 6 shows an example of an enterprise including a first site and a second site, both implementing the means for sending and the means for receiving as shown in FIG. 1A.

FIG. 7 shows an example as a detail of FIG. 1A, with the first network including a wireless physical transport and the second network including a wireline physical transport.

FIG. 8 shows an example of a service provider, who may support a specific device and/or support a specific messaging service through that device.

FIG. 9 shows an example that any of the means disclosed herein may include at least one instance of a Finite State Machine (FSM), and/or a computer, and/or a program system that may reside in a memory accessibly coupled to the computer. A computer readable memory and a server may be configured to provide the program system and/or an installation package to the computer.

### DESCRIPTION

Embodiments of the invention measure message stream quality across networks where the message stream employs a network service, such as Voice Over Internet Protocol (VOIP). The networks may employ wireline communication, wireless communication, or a combination of wireline and wireless communication supporting message-based communication. The messages traverse from one network including a source device to another network including a destination device, and may pass through intervening networks linking the source and destination devices. In a traverse of a message from a first network to a second network, also referred to as a hop, the message is received into a device, such as a router, and then sent to the other network as part of the traversal. Each network through which a message passes includes at least one device for linking to another network to form a communications path between the source device and the destination device. Wireline communication protocols may refer to messages as packets. Wireless protocols may refer to messages as frames.

Briefly, a method embodiment of the invention may comprise sending streams of service messages to create sent service messages from a source across networks to a destination, receiving responses to the sent service messages to create an estimate of jitter in the travel time of the service message stream, and a packet loss measurement for the service message stream. Jitter in the travel time refers to the measured or alternately estimated variations in the travel times of different sent service messages in the stream of service messages.

At least two devices are traversed by the sent service messages to reach the destination. The estimate of the jitter will include the estimate of the jitter across each of these devices. The packet loss measurement will include the packet loss from traversing each of these devices. A service message is a message specifying a specific messaging service. Examples of the specific messaging service include, but are not limited to, any of the following: Voice Over Internet Protocol (VOIP), web access, video, video phone, gaming, 3-D gaming, and Virtual Desktop Infrastructure (VDI). The receiving of the response may further create an estimate of the travel time to and from each of the devices traversed in the networks.

Quality of service for one of the devices may include the estimate of jitter and packet loss measurement. Quality of service may also include the travel time across the device for the sent service messages. More than one measured, estimated, or computed parameter or subjective evaluation may be combined to determine a quality of service for a messaging service. A method embodiment of the invention may further include communicating the quality of service for the device with the service provider responsible for that device.

Sending streams of the service messages may further include sending the sent service messages with a device count selected from a successive device count list starting at one. As the sent service message traverses a device, the device count of the sent service message is examined, and if the device count is zero, the device discards the sent service message and responds by sending a response message about the sent service message it discarded. If the device count of the sent service message is greater than zero, the device count of the service message is decremented. The device then sends the altered sent service message on to the next device or to the destination.

When the destination receives the sent service message, it sends a response to the source, notifying the source that the sent service message has been received. The source receives the response to the sent service messages as either notification that the sent service message was discarded because the device count had decremented to zero, or notification that the destination received the sent service message.

In an example of an embodiment of the invention, the successive device count list may include one, two, three, and successively larger integers up to a largest integer. In another implementation, the successive device count list may contain the same integers, but differently ordered. In another example, an embodiment of the invention may employ a successive device count list starting at zero and incrementally including the integers up to the largest integer.

Sending the stream of service messages may include sending the sent service messages of a specific device count with a specific message rate. The specific message rate may specify a message count of messages per time period, or a time delay between sent service messages. The jitter, packet loss and/or travel time may be generated for more than one specific message rate, which may support quality of service estimates indicating traffic throttling by the service providers managing a specific device.

Sending streams of messages may include sending streams of service messages for more than one of the specific messaging services. The quality of service reports may show the quality of service for one specific device for at least two of these messaging services.

An embodiment of the invention may further include at least one of the following: assessing which of the devices in the networks are causing a degradation in the quality of service for a site; and assessing from sources at multiple sites which of the devices in the networks are causing a degradation in the quality of service for one or more of the sites.

Another example of an embodiment of the invention includes sending a stream of service messages to create sent service messages from a source in a first network to a destination in a second network and receiving responses to the sent service messages to create an estimate of jitter in a travel time between the source and the destination of the stream of service messages and a packet loss measurement of the stream of service messages. Optionally, each of the first and second networks includes at least one device traversed by the sent service messages to reach the destination. The jitter estimate optionally includes the jitter in a travel time across each of the devices. The packet loss measurement optionally includes a measurement of packet loss at each of the devices. At least one of the service messages may optionally be a message specifying a messaging service. Examples of the messaging service include, but are not limited to, Voice Over Internet Protocol (VOIP), World Wide Web access, video phone, gaming, and 3-D gaming.

Each of the networks comprises a wireline physical transport for communicating data between devices, or a wireless physical transport for communicating data between devices, or a combination of wireline and wireless physical transport. Sending the stream of service messages optionally further includes sending each of the sent service messages with a device count selected from a successive device count list, and may include receiving the responses, including creating the estimate of jitter for the device discarding the service message with the device count decremented to zero, and creating the packet loss measurement for the device discarding the sent service message with the device count decremented to zero. Sending the stream of service messages optionally further includes sending the sent service messages at a specific message rate and receiving responses to the sent service messages. Receiving responses to the sent service messages optionally further includes creating the estimate of jitter for the specific message rate, and creating the packet loss measurement for the specific message rate.

Embodiments of the invention optionally include of communicating with a service provider for at least one of the devices a quality of service based upon the estimate of jitter and the packet loss measurement at the at least one of the devices. An embodiment of the invention optionally further includes operating at a first source and a second source. Operating at the first source further includes sending a first stream of the service message to create a first of the sent service messages from the first source across a first of the networks to the destination, and receiving a first of the responses to the first of the sent service messages to create the estimate of jitter in the travel time between the first source and the destination and the packet loss measurement. Operating the second source optionally includes sending a second stream of the service message to create a second of the sent service messages from the second source across a second of the networks to the destination, and receiving a second of the responses to the second of the sent service messages to create the estimate of jitter in travel time between the second source and the destination, and the packet loss measurement.

Continuing with the previous example, embodiments of the invention optionally include assessing which of the devices in the networks are degrading the quality of service based upon the estimates of jitter and packet loss measurements. Furthermore, a service provider of one of the devices may optionally operate a first agent at at least one source to generate the estimate of jitter and the packet loss measurement from the at least one source to a selected one or more of the devices, and operates a second agent at the selected device to generate the estimate of jitter and the packet loss measurement from the source to the selected device.

Service providers supporting a specific messaging service may use agents at both the source and the destination. These agents support creating quality of service reports for the messaging service, from the source to the destination, and from the destination to the source. These agents will be discussed below with regards to the apparatus.

An apparatus embodiment of the invention may include means for sending streams of service messages to create the sent service messages from the source across the networks to the destination, means for receiving the responses to the sent service messages to create the estimate of the jitter in the travel time of the service message stream, and the packet loss measurement for the service message stream. An apparatus in accord with an embodiment of the invention may further include the means for communicating the quality of service for the device with the service provider responsible for that device. Any of these means may include at least one instance of a Finite State Machine, and/or a computer, and/or a program system that may reside in a memory accessibly coupled to the computer. The program system may implement part, or all, of a method embodiment of the invention. Embodiments of the invention may also include a computer readable memory, a server, or a combination of a computer readable memory and a server, any of which may be configured to deliver the program system, the installation package to the computer, or a combination of the program system and the installation package. The installation package may be configured to instruct the computer to install the program system.

An embodiment of the invention may include one of the devices configured to include the means for sending and the means for receiving. The device may be communicatively coupled to a network and the device may be configured to send the estimate of the jitter and the packet loss measurement to a service provider of the network. Examples of a means for sending include, but are not limited to, a computing device with at least one network interface card that is connected to a network. The means for sending may include a physical connection comprising a cable such as, but not limited to, a T1 DS1 serial connection, a 10 megabit/second Ethernet connection, a 100 megabit/second Ethernet connection, 1 gigabit/second Ethernet connection, or a 10 gigabit/second Ethernet connection. The means for sending may optionally comprise a wireless connection, for example a wireless connection in accord with IEEE-802.11 or a cellular network standard. Computing devices connected to a network by any of the previous examples of a means for sending comprise examples of a transmitting agent.

Examples of a means for receiving include, but are not limited to, a computing device with at least one network interface card that is connected to a network. The means for receiving may include a physical connection comprising a cable such as, but not limited to, a T1 DS1 serial connection, a 10 megabit/second Ethernet connection, a 100 megabit/second Ethernet connection, 1 gigabit/second Ethernet connection, or a 10 gigabit/second Ethernet connection. The means for receiving may optionally comprise a wireless connection, for example a wireless connection in accord with IEEE-802.11 or a cellular network standard. Computing devices connected to a network by any of the previous examples of a means for receiving comprise examples of a receiving agent.

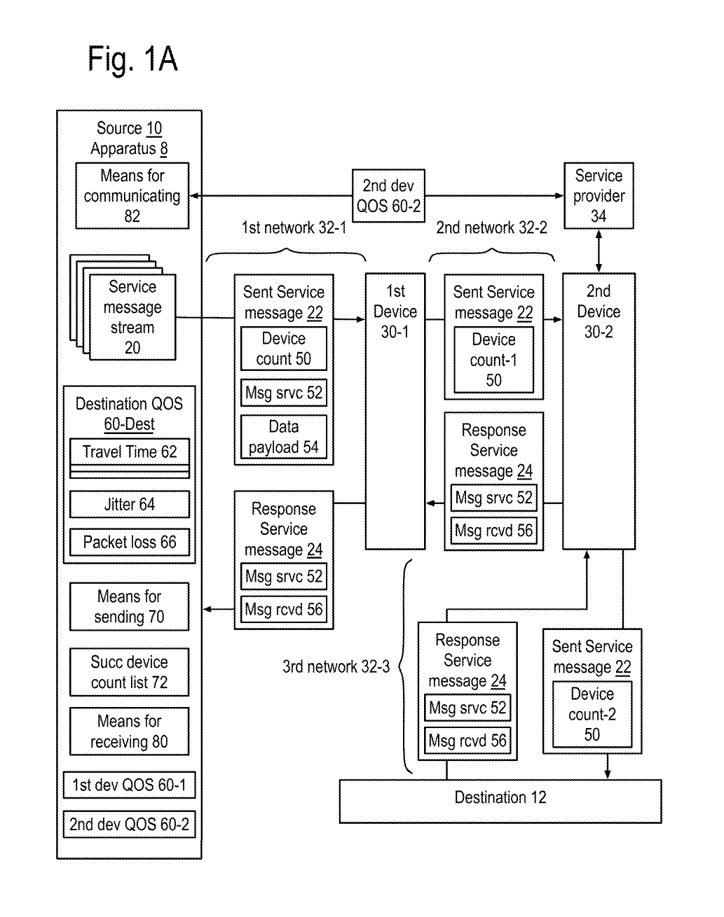

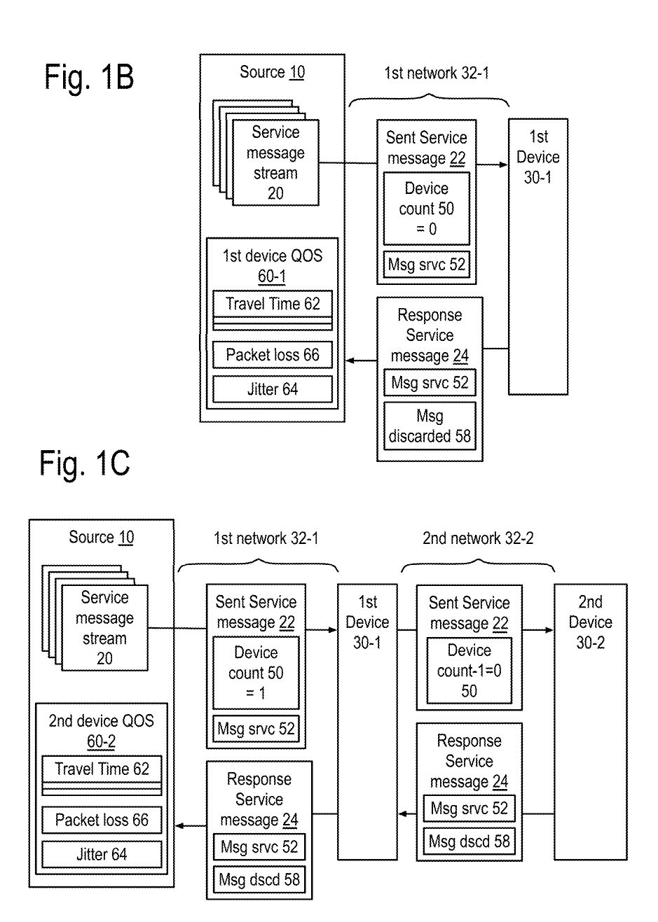

Turning now to the figures, FIGS. 1A to 1C show an example of a method embodiment of the invention for sending the stream 20 of service messages 22 from a source 10 through first network 32-1 to second network 32-3 to a destination 12 to create quality of service estimates for the entire communications path 60-Dest and for the devices 30-1 and 30-2 traversed. The quality of service 60-1 refers to the first device 30-1. The quality of service 60-2 refers to the second device 30-2. The structure of each of the quality estimates 60-Dest, 60-1 and 60-2 will be referred to in general as a quality estimate 60, and will include a collection of travel times 62, a packet loss 66 and will derive a jitter 64 for at least some of the travel times 62 as a variation of the travel times 62. Each of the sent service messages 22 include a device count 50, a message service 52 and possibly a data payload 54, any one or more of which may be empty. The response service message 24 may originate at the destination 12 or at any of the traversed devices 30-1 and 30-2.

FIG. 1A shows an example of the response service message 24 originating at the destination in response to the receipt of the sent service message 22. FIG. 1B shows an example of the response service message 24 originating at the first device 30-1 in response to the incoming sent service message 22 having its device count from 1 to 0. The first device 30-1 has discarded the sent service message 22 and its response service message 24 indicates the message has been discarded 58. FIG. 1C shows an example of the response service message 24 originating at the second device 30-2 in response to the incoming sent service message 22 having its device count from 1 to 0. The second device 30-2 has discarded the sent service message 22 and its response service message 24 indicates the message has been discarded 58.

FIG. 1A also shows an example of the source 10 implementing apparatus 8 including the means for sending 70 the stream 20 of service messages to create the sent service message 22 from the source 10 across the networks 32-1, 32-2 and 32-3 to the destination 12. The source 10 also includes the means for receiving 80 the responses 24 to the sent service messages 22 to create an estimate of the jitter 64 in the travel time 60 and a packet loss measurement 66 for the service message stream 20. The example of an apparatus 8 optionally further includes the means for communicating 82 the quality of service 60-2 for the device 30-2 with the service provider 34 responsible for that device 30-2, in this example. These travel times 62, the jitter 64 derived from the travel times 62 and the packet loss 66 are organized by the means for receiving 80 into distinct quality of service 60 estimates for the following: the destination 12, quality of service 60-Dest as shown in the example of FIG. 1A, the first device 30-1, quality of service 60-1 discussed in regard to the example of FIG. 1B, and the second device 30-2, quality of service 60-2 discussed in the example of FIG. 1C.

Sending 70 streams 20 of the service messages may further include sending the sent service messages 22 with a device count 50 selected from a successive device count list 72 starting at one as shown in FIG. 1B. As the sent service message 22 traverses each of the devices 30-1 and 30-2, which will be generically referred to as the device 30, the device count 50 of the sent service message 22 is examined, and if the device count 50 is zero, the device 30 discards the sent service message 22 and responds by sending a response message 24 about the sent service message it discarded 58. FIG. 1B shows an example of this being done by device 30-1. FIG. 1C shows an example of this being done by device 30-2.

If the device count 50 of the sent service message 22 is greater than zero, the device 30 alters the sent service message 22 before it enters the next network 32 by decrementing the device count 50. The example of FIG. 1A shows this twice. The first device 30-1 then sends the altered sent service message 22 on to the next, second device 30-2 leading to the destination 12. The second device 30-2 sends this on to the destination 12. When the destination 12 receives the sent service message 22, it sends a response message 24 to the source 10, notifying the source 10 that the sent service message has been received 56. The source 10 receives 80 the response message 24 to the sent service messages 22 as either notification that the sent service message was discarded 58 because the device count 50 had decremented to zero, or notification that the destination 12 received 56 the sent service message 22.

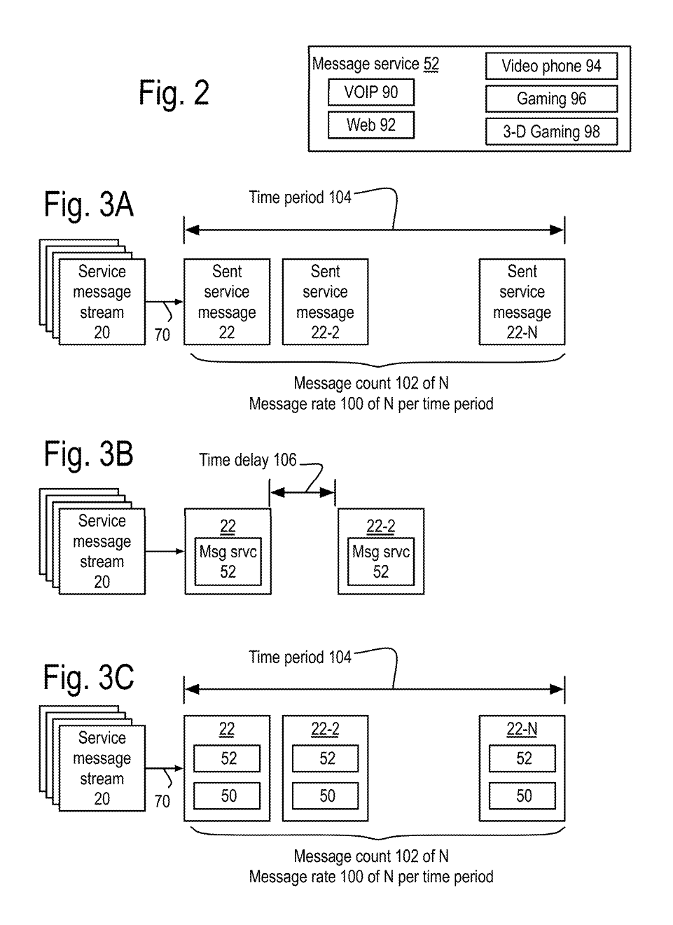

As shown in the example of FIG. 2, the message service indication 52 may be any of Voice Over Internet Protocol 90 (VOIP), Web access 92, a video phone 94, gaming 96 or possibly 3-D gaming 98.

FIGS. 3A to 3C show some examples of sending 70 the stream 20 of service messages at a specific message rate 100. FIG. 3A shows the specific message rate 100 may specify a message count 102 of service messages 22 be sent per time period 104. FIG. 3B shows the specific message rate 100 may specify a time delay 106 between sent service messages 22 and for example, 22-2. FIG. 3B also shows that the service messages 22 may all share the same messaging service indication 52. FIG. 3C shows the sending 70 may include sending 70 the sent service messages 22-1 to 22-N for a specific device count 50 with a specific message rate 100. This example may be of particular use in determining which device 30 may be throttling the message rate 100 for a specific message service 52.

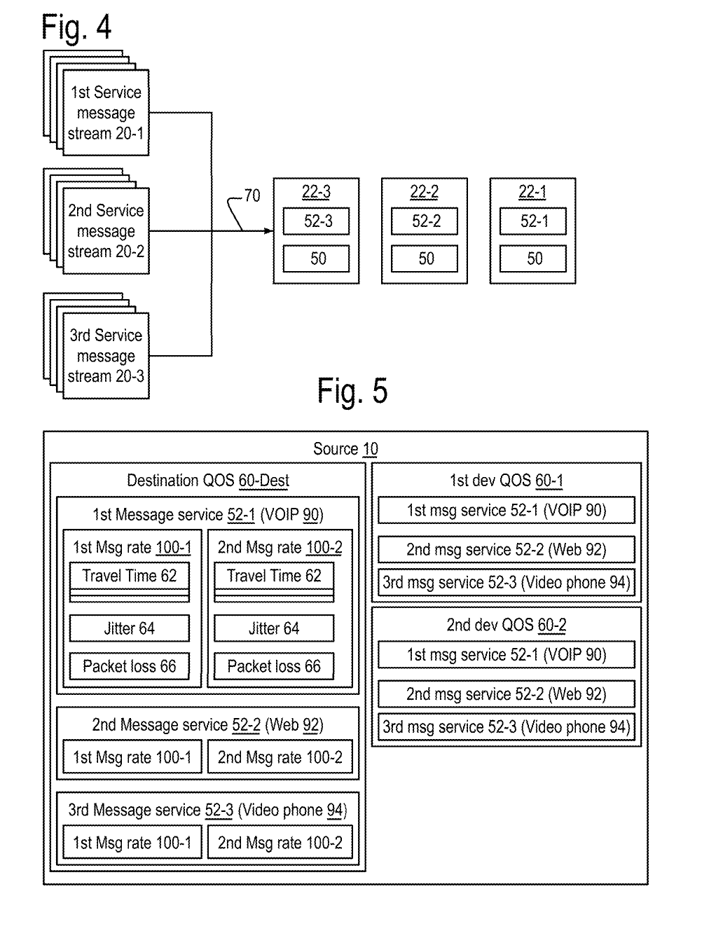

FIG. 4 shows an example of sending 70 multiple streams. First service message stream 20-1, second service message stream 20-2, and third service message stream 20-3 may include sending streams 20 of service messages for more than one of the specific messaging services, for example 52-1, 52-2 and 52-3, and optionally a specific device count 50. The quality of service reports 60-Dest, 60-1 and 60-2 may show the quality of service for one specific device, for instance 30-1 for at least two of these messaging services 52 as shown in the next Figure.

FIG. 5 shows the jitter 64, the packet loss 66 and/or the travel time 62 may be generated for more than one specific message rate 100, and for more than one messaging service 52 which may support quality of service estimates 60 indicating traffic throttling by the service providers 34 managing the devices 30-1 and/or 30-2.

Each of the quality of service estimates 60-Dest, 60-1 and 60-2 shown in FIG. 1A may include separate components for multiple messaging services 52-1, 52-2, and 52-3 and for those messaging services, may further generate and collect the jitter 64, the packet loss 66 and/or the travel times 62 for more than one message rate 100-1 and 100-2. In some situations, the message rates 100-1 and 100-2 may differ for different messaging services 52-1, 52-2 and/or 52-3. In some situations there may be more than two devices 30-1 and 30-2 involved in the routing path from the source 10 to the destination 12. Also, sent messages 22 for different message services 52-1, 52-2 and so on may be found to use different routing paths from the source 10 to the destination 12. So that the list of devices 30-1 and 30-2 may vary depending upon the messaging service 52. The elements of FIG. 4 may be arranged to account for such variations.

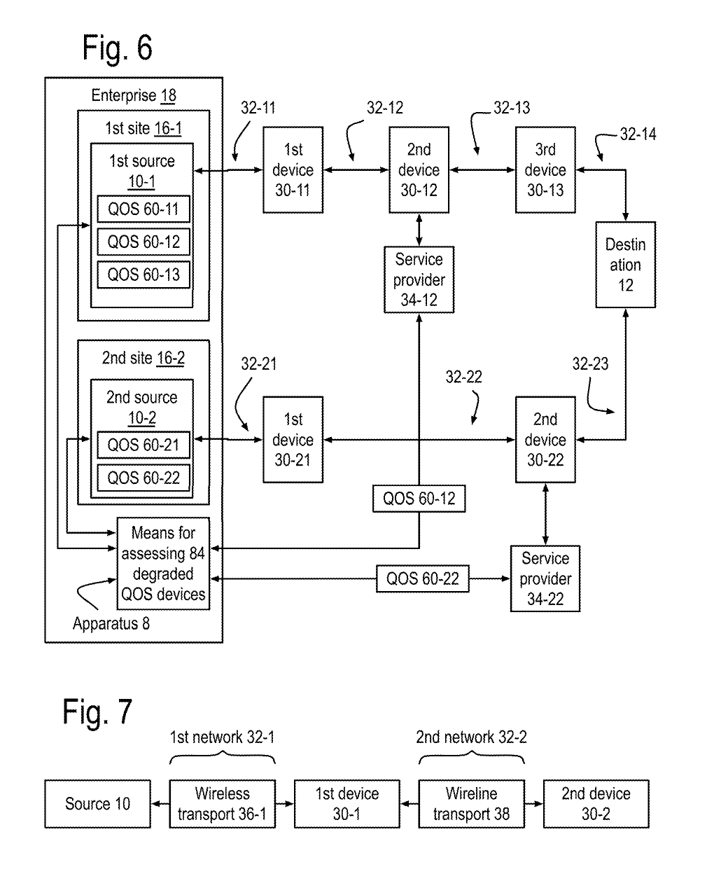

FIG. 6 shows an example of an enterprise 18 including a first site 16-1 with a first source 10-1 and a second site 16-2 with a second source 10-2, both implementing the means for sending 70 and the means for receiving 80 as shown in the example of FIG. 1A. Sources 10-1 in the first site 16-1 may use a first routing path of devices 30-11, 30-12 and 30-13 to send 70 service messages 22 to the destination 12. Sources 10-2 in the second site 16-2 may use a second routing path 30-21 and 30-22 to send 70 service message 22 to the same destination 12.

The example of an apparatus 8 may include the means 84 for assessing which of the devices 30-11 to 30-13, 30-21 and 30-22 in the networks, 32-11 to 32-14 and 32-21 to 32-23, are causing a degradation in the quality of service 60 for a site, such as 16-1. In particular, the means 84 may assess from sources 10-1 and 10-2 at multiple sites 16-1 and 16-2 which of the 30-11 to 30-13, 30-21 and 30-22 in the networks, 32-11 to 32-14 and 32-21 to 32-23, are causing a degradation in the quality of service for the sites. For example, in the example of FIG. 6, a quality of service 60-12 report for device 30-12 may be sent to the service provider 32-12 responsible for the device 30-12. A second quality of service 60-22 report may be sent to the service provider 32-22 responsible for the device 30-22.

Examples of a means for assessing 84 include, but are not limited to, a computing device with at least one network interface card that is connected to a network.

The means for assessing may include a physical connection comprising a cable such as, but not limited to, a T1 DS1 serial connection, a 10 megabit/second Ethernet connection, a 100 megabit/second Ethernet connection, 1 gigabit/second Ethernet connection, or a 10 gigabit/second Ethernet connection. The means for assessing may optionally comprise a wireless connection, for example a wireless connection in accord with IEEE-802.11 or a cellular network standard. The computing device in a means for assessing optionally executes a process of analyzing the results of the received responses to produce assessment metrics in reporting formats including, but not limited to, PDF (Portable Document Format), HTML (Hyper Text Markup Language) format, formats compatible with selected word processors, and so on. A computing device included in a means for assessing is an example of an assessment engine.

FIG. 7 shows an example as a detail of FIG. 1A, with the first network 32-1 including a wireless physical transport 36-1 and the second network 32-2 including a wireline transport 38.

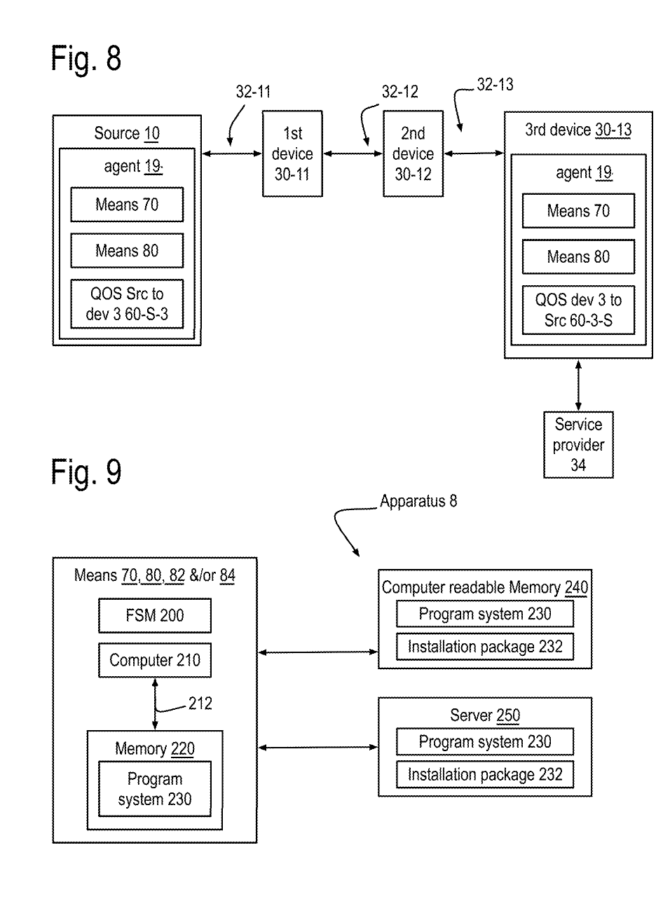

FIG. 8 shows an example of a service provider 34, who may support a specific device 30-13. A specific messaging service, for example, but not limited to, one or more of the examples of a messaging service 52 from FIGS. 1A, 1B, 1C, 2, 3B, and 3C, may optionally be supported through that device 30-13. The service provider 34 may use agents 19 including the means for sending 70 and the means for receiving 80 at both the source 10 and the destination. The third device 30-13 is an example of a destination device. Agents 19 support creating quality of service reports for the messaging service, from the source 10 to the destination 30-13, as Quality of service 60-S-3 and from the destination to the source as 60-3-S.

As shown in the example of FIG. 9, any of these means 70, 80, 82 and 84, may include at least one instance of a Finite State Machine (FSM) 200, a computer 210, and a program system 230, singly or in any combination, that may reside in a memory 220 accessibly coupled 212 to the computer 210. The memory 220 may retain the program system 230 in a non-transitory form, for example as non-transitory information stored in a non-volatile memory component that retains the program system 230 without requiring a continuing supply of power. The computer 210 may include at least one instruction processor and at least one data processor, with at least one data processor configured to be instructed by at least one instruction processor to implement at least part of the means 70, 80, 82 or 84, singly or in any combination.

The apparatus 8 may optionally include a computer readable memory 240 and may optionally include a server 250, either of which may be configured to deliver the program system 230, an installation package 232, or both, to the computer 210. The installation package 232 may be configured to instruct the computer 210 to install the program system 230.

What is claimed is:

1. A method, comprising the steps of:
sending a stream of service messages to create sent service messages from a source in a first network to a destination in a second network; and
receiving responses to said sent service messages to create an estimate of jitter in a travel time between said source and said destination of said stream of service messages and a packet loss measurement of said stream of service messages.

2. The method of claim 1, further comprising the steps of:
traversing said sent service messages through at least one device in said first network and at least one device in said second network;
including in said jitter estimate a jitter in travel time across each of said devices; and
including in said packet loss measurement a measurement of packet loss at each of said devices.

3. The method of claim 1, further comprising the step of specifying a messaging service.

4. The method of claim 3, further comprising the step of selecting said messaging service from a group consisting of Voice Over Internet Protocol (VOIP), World Wide Web access, video phone, gaming, 3-D gaming, and Virtual Desktop Infrastructure.

5. The method of claim 1, further comprising the steps of:
sending each of said sent service messages with a device count selected from a successive device count list; and
creating said estimate of jitter when said device discards said sent service message with said device count decremented to zero; and
creating said packet loss measurement when said device discards said sent service message with said device count decremented to zero.

7. The method of claim 1, further comprising the steps of:
sending said sent service messages at a specific message rate;
creating said estimate of jitter for said specific message rate; and
creating said packet loss measurement for said specific message rate.

8. The method of claim 1, further comprising the step sending a quality of service based upon said estimate of jitter and said packet loss measurement for at least one of said devices.

9. The method of claim 1, further comprising the steps of:
sending a first stream of said service messages to create a first of said sent service messages from said first of said source across a first of said networks to said destination;
receiving a first of said responses to said first of said sent service messages to create said estimate of jitter in said travel time between said first of said source and said destination and said packet loss measurement;
sending a second stream of said service messages to create a second of said sent service messages from said second of said source across a second of said networks to said destination; and
receiving a second of said responses to said second of said sent service messages to create said estimate of jitter in said travel time between said second of said source and said destination and said packet loss measurement.

10. The method of claim 9, further comprising the step of assessing which of said devices in said networks are degrading a quality of service based upon said estimates of jitter and said packet loss measurements.

11. The method of claim 1, further comprising the steps of:
operating a first agent at a first of said source to generate said estimate of jitter and said packet loss measurement from said source to one of said devices; and
operating a second agent at a second of said source to generate said estimate of jitter and said packet los measurement from said source to said one of said devices.

12. An apparatus, comprising:
means for sending a stream of service message to create sent service messages from a source across networks to a destination; and
means for receiving responses to said sent service messages to create an estimate of jitter in a travel time between said source and said destination of said stream of said service messages and a packet loss measurement of said stream of said service messages.

13. The apparatus of claim 12, wherein said networks include at least two devices traversed by said sent service messages to reach said destination, said jitter includes said estimate of jitter of said travel time across each of said devices, and said packet loss measurement includes said packet loss measurement at each of said devices.

14. The apparatus of claim 12, wherein said service message is a message specifying a messaging service.

15. The apparatus of claim 14, wherein said messaging service is one of Voice Over Internet Protocol (VOIP), web access, video phone, gaming, 3-D gaming, and Virtual Desktop Infrastructure (VDI).

16. The apparatus of claim 12, wherein at least one of said networks supports at least one of a wireline physical transport and a wireless physical transport.

17. The apparatus of claim 12, wherein:
the means for sending said stream of said service messages sends said sent service message at a specific message rate; and
the means for receiving creates said estimate of said estimate of jitter for said specific message rate and said packet loss measurement for said specific message rate.

18. The apparatus of claim 12, further comprising:
a first of said source;
a second said source;
a first stream of service messages from said first source to said destination;
a second stream of service messages from said second source to said destination;
an estimate of jitter and a packet loss measurement between said first source and said destination; and
an estimate and a packet loss measurement between said second source and said destination.

19. The apparatus of claim 12, further comprising means for assessing which of said devices in said networks are degrading quality of service based upon said estimates of said jitter and said packet losses.

20. The apparatus of claim 12, further comprising at least one of a computer readable memory and a server, both configured to deliver an installation package to said computer, wherein said installation package is configured to instruct said computer to install a program system.
